(19) United States
(12) Patent Application Publication
(10) Pub. No.: US 2026/0365030 A1
(43) Pub. Date: Nov. 19, 2026

(54) METHOD FOR CONTROLLING A VEHICLE DRIVETRAIN

(71) Applicant: MAGNA Powertrain GmbH & Co KG, Lannach (AT)

(72) Inventors: Elias PRITZI, WIEN (AT); Maximilian BRUNNER, VITIS (AT); Nestoras KASPSCHIK, BADEN (AT); Alexander ZEILER, BAD VOESLAU (AT)

(21) Appl. No.: 19/672,887

(22) Filed: May 11, 2026

(30) Foreign Application Priority Data
May 13, 2025 (DE) 102025118424.0

(51) Int. Cl. B60L 3/00

(52) U.S. Cl. CPC B60L 3/0061

(57) ABSTRACT

A method for controlling a vehicle powertrain comprising an electric machine and an inverter connected to the electric machine for control purposes, comprising, based on the receipt of a safe-state request: generating a first state comprising an all-switches-open, ASO, mode for controlling phase terminals of the electric machine for a first time period; and generating a second state comprising a switching interval comprising an all-switches-open, ASO, portion and an active short-circuit, ASC, portion for controlling the phase terminals of the electric machine for a second time period, wherein during the second state the all-switches-open, ASO, portion is reduced.

### CROSS-REFERENCE TO RELATED APPLICATIONS

This application claims priority to German Application No. 102025118424.0, filed on May 13, 2025. The entire disclosure of the above application is incorporated herein by reference.

### FIELD OF THE INVENTION

The present invention relates to a method for controlling a vehicle powertrain comprising an electric machine and an inverter connected to the electric machine for control purposes, comprising, based on the receipt of a safe-state request:
generating a first state comprising an all-switches-open, ASO, mode for controlling phase terminals of the electric machine for a first time period; and
generating a second state comprising a switching interval comprising an all-switches-open, ASO, portion and an active short-circuit, ASC, portion for controlling the phase terminals of the electric machine for a second time period.

Furthermore, the invention relates to an electric vehicle powertrain and a computer program product comprising a control program.

### BACKGROUND OF THE INVENTION

Electric vehicles often feature an electric powertrain including a permanently excited electric machine, wherein the phase terminals of the electric machine are connected to an inverter. If a fault occurs during driving, electrical power is generated in the regenerative mode of the electric machine during coasting. If the phase terminals of the electric machine are open-circuited, i.e., not short-circuited by switches of the inverter, a high voltage may occur that can destroy electrical components, such as components of the inverter or components connected to the DC side of the inverter. For this reason, the electric machine can be operated in an active short-circuit mode, i.e., in a state in which the phase terminals are intentionally connected to one another (e.g., via switches in the inverter). However, high currents can occur in the active short-circuit mode. These so-called transient overcurrents can often reach 2 to 3 times the operating current and thus damage the inverter and partially demagnetize the magnets of the electric machine. For the inverter, the low-temperature scenario is critical, while the magnets of the electric machine are sensitive at high operating temperatures, as the coercive field strength is lower there.

In principle, it is possible to counter this damage mechanism by designing the relevant components to be more robust. However, such an oversized design represents an excessive use of resources, which negatively impacts both manufacturing costs and the ecological footprint.

However, there are also switching methods known from the prior art in which the phase terminals of the electric machine are operated alternately in active short-circuit and all-switches-open modes.

However, the methods known from the prior art have the disadvantage that transient overcurrents cannot be completely reduced across the entire operating range of the electric motor. Furthermore, the known methods do not achieve a significant reduction in the overcurrent in the event of a sudden opening of the battery switch, a so-called load dump event.

There is therefore a need for an improved method across the entire motor operating range to enable a greater reduction in overcurrent, particularly during the sudden opening of the battery switch.

### SUMMARY OF THE INVENTION

This object is achieved by a method having the features of claim 1.

Accordingly, the method comprises the step of: reducing, during the second state, the all-switches-open, ASO, portion.

A vehicle powertrain with an electric machine may include a three-phase motor, and the inverter is connected to the three-phase motor for control purposes. In an inverter used in a vehicle powertrain, electronic switching technologies may be employed, such as: bipolar transistors with an insulated gate electrode, also known as IGBTs (insulated gate bipolar transistors), and field-effect transistors with an insulated gate electrode, also known as MOSFETs (metal-oxide-semiconductor field-effect transistors), and, in particular, power transistors made of silicon carbide (SiC).

The inverter may include a control device, or be connected to a control device, for controlling the three-phase motor in particular.

The safe-state request can be understood here as a request or a signal to transition the electric machine to a safe state in the event of a fault and can also be understood as a safe-state request sent from a central control unit to the inverter. The safe state can be understood as an operating point and may optionally comprise an active short circuit, ASC, also referred to as a short circuit or short-circuit mode, or an all-switches-open, ASO, state also referred to as an all-switches-open mode. In active short circuit/short-circuit mode, some or all of the phase windings of the electric machine are short-circuited using the inverter's power semiconductor switches. This mode can be established with various switch positions of the semiconductor switches. In the all-switches-open state, the inverter's control device is switched off. This causes the power semiconductor switches to be brought into the open state.

To transition to the safe state, the overall vehicle safety concept often allows only a time period of 10 ms.

According to the claimed method, a first state is generated for a first time period, comprising an all-switches-open, ASO, mode of the phase terminals of the electric machine. The second state comprises a switching interval that includes, for a second time period, an all-switches-open, ASO, portion and an active short-circuit, ASC, portion for the phase terminals of the electric machine. The second state can be generated immediately following the first state.

In this case, switching occurs periodically or aperiodically between the all-switches-open and short-circuit states during the duration of the second time period.

According to the invention, during the second state, the all-switches-open, ASO, portion is reduced. In this case, the all-switches-open portion may be reduced constantly over the duration of the second time period, or be reduced in one or more steps during the second time period. While the all-switches-open portion is being reduced, the short-circuit portion may be increased accordingly, such that during the second time period the phase terminals are either open or short-circuited.

The method described herein may also be referred to as hybrid coordinated switching.

In one embodiment, the second time period follows directly after the first time period. In alternative embodiments, there may be an additional time period between the first time period and the second time period during which the phase terminals are short-circuited or in the all-switches-open mode.

In one embodiment, the first time period is shorter than or equal to 500 μs, specifically between 200 μs and 500 μs. In a preferred embodiment, the first time period is greater than a preceding PWM period and less than or equal to 500 μs.

To maximize the reduction potential, the phase terminals of the electric machine are first operated in the all-switches-open mode for a time period shorter than or equal to 500 μs, specifically between 200 μs and 500 μs, and/or preferably within a range between a preceding PWM period and 500 μs. This results in a reduction in the transient overcurrent during the second time period and thus protects the drive components of the system.

In one embodiment, the second time period has a duration in a range of 1-10 ms, in particular 7 ms.

In one embodiment, the reduction involves a linear reduction of the all-switches-open portion. The linear reduction can occur from a first value at the beginning of the second time period to a second value at the end of the second time period. The short-circuit portion is increased linearly during the second time period.

In one embodiment, the ratio between the all-switches-open, ASO, portion and the active short-circuit, ASC, portion at the beginning of the second time period ranges from 70% all-switches-open and 30% short circuit up to 30% all-switches-open and 70% short circuit, and at the end of the second time period is 0% all-switches-open and 100% short circuit.

In one embodiment, a switching time of the switching interval lies in a range from 0.05 ms to 1 ms.

In one embodiment, the method includes the step of: generating a third state comprising an active short circuit, ASC, of the phase terminals of the electric machine for a third time period, wherein the third time period follows directly after the second time period.

During the third time period, the phase terminals may remain short-circuited for a specific time period until the end of the safe state.

The invention further relates to an electric vehicle powertrain comprising an inverter and an electric machine, wherein a control device is provided that is connected to the inverter for control purposes and is configured to execute the method described herein.

Furthermore, the invention relates to a computer program product comprising a control program configured to execute the method described herein.

### DRAWINGS

The concept underlying the invention will be explained in more detail below with reference to the exemplary embodiments illustrated in the figures, in which

FIG. 1 shows a phase current diagram of an electric machine during execution of the method according to an embodiment of the invention; and

FIG. 2 shows a view of the steps of the method according to an embodiment of the invention.

### DETAILED DESCRIPTION OF THE INVENTION

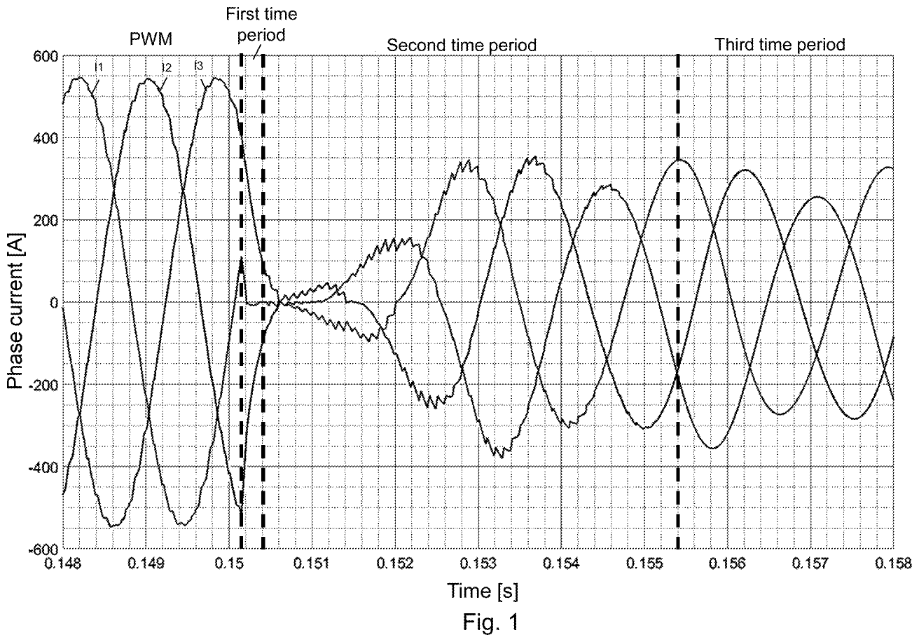

FIG. 1 shows a view of the three phase currents 11, 12, 13 of an electric machine during the execution of the method according to an embodiment of the invention.

The y-axis shows the phase current in amperes, A, and the x-axis shows time in seconds, s. Before the start of the first time period, i.e., before a safe-state request is received, the inverter controls the electric machine based on space vector modulation (SVPWM). SVPWM is a method for controlling rotating electric machines based on pulse width modulation.

Upon receipt of the safe-state request, i.e., for a first time period lasting 500 μs, the phase terminals of the electric machine are operated in the all-switches-open mode.

In the illustrated embodiment, the second state, or the second time period, follows directly after the first state, or the first time period. The second state includes a switching interval that comprises an all-switches-open, ASO, portion and a short-circuit, ASC, portion for the phase terminals of the electric machine during a second time period.

At the start of the second time period, the all-switches-open portion is 60% and the short-circuit portion is 40%. The all-switches-open portion is reduced constantly over the duration of the second time period and is 0% all-switches-open at the end of the second time period, with the short-circuit portion being 100% at the end of the second time period. As the all-switches-open portion is reduced, the short-circuit portion is increased by the same amount, such that during the second time period the phase terminals are either open or short-circuited. In the illustrated embodiment, the second time period has a duration of 7 ms and falls within the normal switching frequency of the system during normal operation.

In the illustrated embodiment, the method further includes a third time period following the second time period, wherein during the third time period the phase terminals of the electric machine are short-circuited.

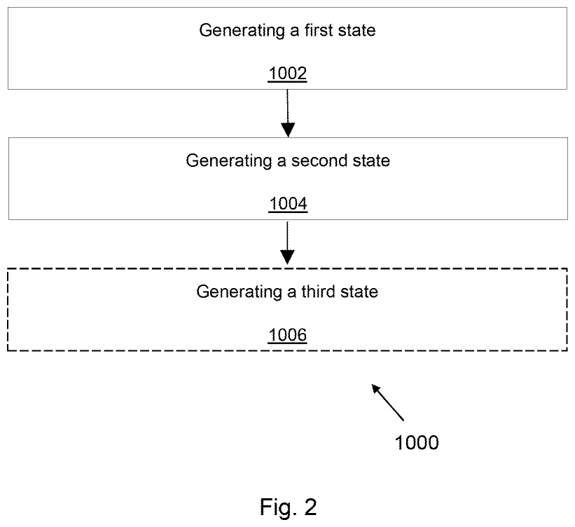

FIG. 2 shows a view of the method steps of the method 1000 for controlling a vehicle powertrain comprising an electric machine and an inverter connected to the electric machine for control purposes, and comprising the following steps based on the receipt of a safe-state request:
generating 1002 a first state comprising an all-switches-open, ASO, mode for controlling phase terminals of the electric machine for a first time period; and
generating 1004 a second state comprising a switching interval comprising an all-switches-open, ASO, portion and an active short-circuit, ASC, portion for controlling the phase terminals of the electric machine for a second time period, wherein during the second state, the all-switches-open, ASO, portion is reduced.

The method may further, or optionally, include the step of: generating 1006 a third state comprising an active short circuit, ASC, of the phase terminals of the electric machine for a third time period, wherein the third time period follows directly after the second time period.

1. A method for controlling a vehicle powertrain comprising an electric machine and an inverter connected to the electric machine for control purposes, comprising, based on the receipt of a safe-state request:
generating a first state comprising an all-switches-open, ASO, mode for controlling phase terminals of the electric machine for a first time period; and
generating a second state comprising a switching interval comprising an all-switches-open, ASO, portion and an active short-circuit, ASC, portion for controlling the phase terminals of the electric machine for a second time period, reducing, during the second state, the all-switches-open, ASO, portion.

2. The method according to claim 1, wherein the second time period follows directly after the first time period.

3. The method according to claim 1, wherein the first time period is shorter than or equal to 500 μs, in particular between 200 μs and 500 μs.

4. The method according to claim 1, wherein the first time period is greater than a preceding PWM period and less than or equal to 500 μs.

5. The method according to claim 1, wherein the second time period has a duration in a range of 1-10 ms, in particular 7 ms.

6. The method according to claim 1, wherein the reduction comprises a linear reduction of the all-switches-open, ASO, portion.

7. The method according to claim 1, wherein the ratio between the all-switches-open, ASO, portion and the active short-circuit, ASC, portion at the beginning of the second time period lies in a range from 70% all-switches-open and 30% short circuit to 30% all-switches-open and 70% short circuit, and at the end of the second time period is 0% all-switches-open and 100% short circuit.

8. The method according to claim 1, wherein a switching time of the switching interval lies in a range from 0.05 ms to 1 ms.

9. The method according to claim 1, comprising the step of:
generating a third state comprising an active short circuit, ASC, of the phase terminals of the electric machine for a third time period, wherein the third time period follows directly after the second time period.

10. An electric vehicle powertrain comprising an inverter and an electric machine, wherein a control device is provided that is connected to the inverter for control purposes and is configured to execute the method according to claim 1.

11. A computer program product comprising a control program configured to execute the method according to claim 1.
